(19) United States
(12) Patent Application Publication
(10) Pub. No.: US 2023/0315454 A1
(43) Pub. Date: Oct. 5, 2023

(54) FUSING NO-OP (NOP) INSTRUCTIONS

(71) Applicant: ADVANCED MICRO DEVICES, INC., Santa Clara, CA (US)

(72) Inventor: KAI TROESTER, BOXBOROUGH, MA (US)

(21) Appl. No.: 17/708,216

(22) Filed: Mar. 30, 2022

(51) Int. Cl. G06F 9/30

(52) U.S. Cl. CPC G06F 9/30076; G06F 9/3004

(57) ABSTRACT

A method of fusing no-op (NOP) instructions includes receiving a no-op (NOP) instruction and generating, based on the NOP instruction and at least one other instruction, a fused NOP instruction.

### BACKGROUND

A no-op (NOP) instruction is an instruction that, when executed, effectively “does nothing” in that it does not modify the state of any programmer-accessible memory, registers, or flags. NOP instructions are used in various scenarios, such as to force particular timings, memory alignments, preventing hazards, and the like. Though a NOP instruction “does nothing,” execution of the NOP instruction requires some amount of computational and power resources in order to flow through an execution pipeline.

### BRIEF DESCRIPTION OF THE DRAWINGS

FIG. 1 is a block diagram of an example processor for fusing no-op (NOP) instructions according to some implementations.

FIG. 2 is a flowchart of an example computer for fusing no-op (NOP) instructions according to some implementations.

FIG. 3 is a flowchart of an example method for fusing no-op (NOP) instructions according to some implementations.

FIG. 4 is a flowchart of another example method for fusing no-op (NOP) instructions according to some implementations.

FIG. 5 is a block diagram depicting an example set of instructions that are candidates for fusing into a fused NOP instruction.

FIG. 6 is a block diagram depicting another example set of instructions that are candidates for fusing into a fused NOP instruction.

FIG. 7 is a block diagram depicting yet another example set of instructions that are candidates for fusing into a fused NOP instruction.

### DETAILED DESCRIPTION

A no-op (NOP) instruction is an instruction that, when executed, effectively “does nothing” in that it does not modify the state of any programmer-accessible memory, registers, or flags. NOP instructions are used in various scenarios, such as to force particular timings, memory alignments, preventing hazards, and the like. Though a NOP instruction “does nothing,” execution of the NOP instruction requires some amount of computational and power resources in order to flow through an execution pipeline.

The present specification sets forth various implementations for fusing NOP instructions. In some implementations, method of fusing no-op (NOP) instructions includes: receiving a plurality of instructions including a no-op (NOP) instruction; and generating, based on the NOP instruction and at least one other instruction, a fused NOP instruction including a single instruction that, when executed, causes a same resultant state as executing the NOP instruction and the at least one other instruction.

In some implementations, the method further includes executing the fused NOP instruction instead of the NOP instruction and the at least one other instruction. In some implementations, executing the fused NOP instruction includes incrementing an instruction pointer by a total instruction size of the NOP instruction and the at least one other instruction. In some implementations, the at least one other instruction includes one or more other NOP instructions. In some implementations, the at least one other instruction includes a non-NOP instruction. In some implementations, the fused NOP instruction includes a parameter indicating a total instruction size of the NOP instruction and the at least one other instruction. In some implementations, the fused NOP instruction includes a parameter indicating a number of instructions fused into the fused NOP instruction. In some implementations, the fused NOP instruction includes an opcode from the at least one other instruction.

The present specification also describes various implementations of a processor for fusing no-op (NOP) instructions. Such a processor includes an instruction fetch unit (IFU) and a decode unit. The decode unit receives, from the IFU, a plurality of instructions including a no-op (NOP) instruction. The decode unit also generates, based on the NOP instruction and at least one other instruction, a fused NOP instruction.

In some implementations, the processor further includes an execution unit, where the decode unit provides the fused NOP instruction to the execution unit. In some implementations, the execution unit executes the fused NOP instruction by incrementing an instruction pointer by a total instruction size of the NOP instruction and the at least one other instruction. In some implementations, the at least one other instruction includes one or more other NOP instructions. In some implementations, the at least one other instruction includes a non-NOP instruction. In some implementations, the fused NOP instruction includes a parameter indicating a total instruction size of the NOP instruction and the at least one other instruction. In some implementations, the fused NOP instruction includes a parameter indicating a number of instructions fused into the fused NOP instruction.

Also described in this specification are various implementations of an apparatus for fusing no-op (NOP) instructions. Such an apparatus includes computer memory and a processor operatively coupled to the computer memory. The processor includes an instruction fetch unit (IFU) loading a plurality of instructions from memory and a decode unit. The decode unit receives, from the IFU, the plurality of instructions including a no-op (NOP) instruction and generates, based on the NOP instruction and at least one other instruction, a fused NOP instruction.

In some implementations, the processor further includes an execution unit, where the decode unit provides the fused NOP instruction to the execution unit. In some implementations, the execution unit executes the fused NOP instruction by incrementing an instruction pointer by a total instruction size of the NOP instruction and the at least one other instruction. In some implementations, the at least one other instruction includes one or more other NOP instructions. In some implementations, the at least one other instruction includes a non-NOP instruction.

The following disclosure provides many different implementations, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows include implementations in which the first and second features are formed in direct contact, and also include implementations in which additional features are formed between the first and second features, such that the first and second features are not in direct contact. Further, spatially relative terms, such as “beneath,” “below,” “lower,” “above,” “upper,” “back,” “front,” “top,” “bottom,” and the like, are used herein for ease of description to describe one element or feature's relationship to another element(s) or feature(s) as illustrated in the figures. Similarly, terms such as “front surface” and “back surface” or “top surface” and “back surface” are used herein to more easily identify various components, and identify that those components are, for example, on opposing sides of another component. The spatially relative terms are intended to encompass different orientations of the device in use or operation in addition to the orientation depicted in the figures.

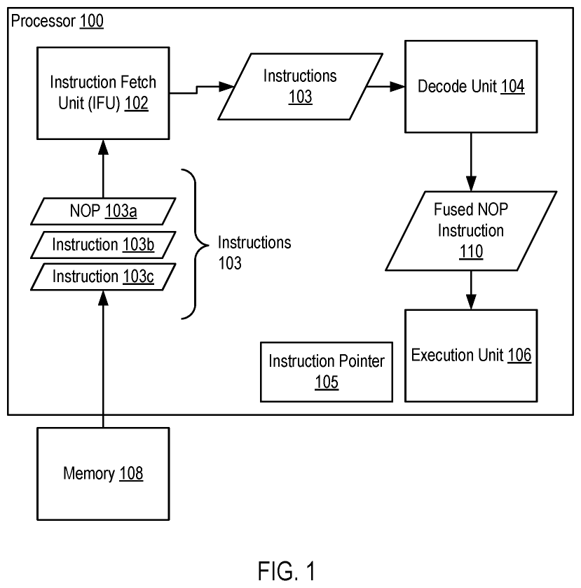

FIG. 1 is a block diagram of a non-limiting example processor 100. The example processor 100 can be implemented in a variety of computing devices, including mobile devices, personal computers, peripheral hardware components, gaming devices, set-top boxes, and the like. The processor 100 includes an instruction fetch unit (IFU) 102. The IFU 102 loads instructions 103 from memory 108. The memory 108 from which the instructions are loaded includes, for example, volatile memory such as Random Access Memory (RAM), non-volatile memory such as disk-based storage, cache memory, or combinations thereof. Although the memory 108 is shown as separate from the processor 100, in some implementations, at least a portion of the memory 108 is located on the processor 100 (e.g., as part of an instruction cache or other component). The IFU 102 loads one or more instructions 103 from an address identified in an instruction pointer 105. The instruction pointer 105 (e.g., a program counter) is a dedicated register that identifies where in program sequence the processor 100 is located.

The IFU 102 then provides the loaded instructions 103 to a decode unit 104 for decoding. The decode unit 104 decodes received instructions 103 for execution. The instructions 103 include one of several possible combinations of a no-op (NOP) instruction and one or more other instructions. A NOP instruction 103a is an instruction that takes some number of clock cycles to execute while not changing the state of any programmable access registers, status flags, or memory.

In some implementations, the instructions 103 include multiple NOP instructions. In other implementations, the instructions 103 include a NOP instruction and a non-NOP instruction. In addition to performing various decode operations, the decode unit 104 also generates a fused NOP instruction 110 from the NOP instruction 103a and at least one other instruction (for example, instruction 103b). The fused NOP instruction 110 is a single instruction that, when executed, causes a same resultant state as independently executing the NOP instruction 103a and the other instruction 103b used to generate the fused NOP instruction 110. The NOP instruction 103a and the other instruction 103b used to generate the fused NOP instruction 110 are hereinafter referred to as being “fused” into the single, fused NOP instruction 110.

In some implementations, the fused NOP instruction 110 is generated based on multiple NOP instructions. That is the ‘other instructions’ fused with a NOP instruction are, in some implementations, also NOP instructions. For example, the instructions 103 in FIG. 1 can include two or more sequentially adjacent NOP instructions 103a, 103b. Thus, execution of the fused NOP instruction 110 results in the same resultant state as individually executing the multiple NOP instructions 103a and 103b fused into the fused NOP instruction 110. For example, execution of the fused NOP instruction 110 causes the instruction pointer 105 to be incremented to reflect the execution of the multiple NOP instructions 103a, 103b, (e.g., by a total instruction size of the multiple NOP instructions 103a, 103b).

In some other implementations, the at least one other instruction 103b used to generate the fused NOP instruction 110 includes a non-NOP instruction (e.g., any other instruction other than a NOP instruction). In such an implementation, the fused NOP instruction 110 of FIG. 1 is generated based on the NOP instruction 103a and a sequentially adjacent non-NOP instruction 103b. Execution of the fused NOP instruction 110 results in the same resultant state as individually executing the NOP instruction 103a and the non-NOP instruction 103b. For example, execution of the single, fused NOP instruction 110 causes the instruction pointer 105 to be incremented to reflect the execution of each individual instruction 103a, 103b, and any memory locations, registers, or status flags affected by the non-NOP instruction 103b are updated accordingly.

In some other implementations, the at least one other instruction used to generate the fused NOP instruction 110 includes a NOP instruction (instruction 103b, for example) and a non-NOP instruction 103c. In such an implementation, the fused NOP instruction 110 is generated based on a sequence of NOP instructions 103a, 103b, and a non-NOP instruction 103c. Execution of such a fused NOP instruction 110 results in the same resultant state as individually executing the NOP instruction 103a, the NOP instruction 103b, and the non-NOP instruction 103c.

Although various implementations of NOP and other instructions are described here as candidates for fusing into a fused NOP instruction, readers will recognize that such implementations are for explanatory purposes only, not limitation. Many different implementations not described are well within the scope of the present disclosure. For example, any combination of NOP and other instructions of any number and type are candidates for fusing into a fused NOP instruction 110.

In some implementations, to generate the fused NOP instruction 110, the decode unit 104 identifies the NOP instruction 103a and the at least one other instruction 103b or 103c in a received block of instructions 103. For example, the decode unit 104 receives a block of data encoding the instructions 103 and breaks the block of data into individual instructions 103a, 103b, and 103c. The decode unit 104 then identifies, in the block of individual instructions 103a, 103b, and 103c, a NOP instruction 103a, and one or more other instructions 103b, 103c sequentially adjacent to the NOP instruction 103a, (e.g., occurring before or after the NOP instruction 103a) to be fused into the fused NOP instruction 110.

In some implementations, the decode unit 104 serially receives individual instructions from the IFU 102, one of which is a NOP instruction 103a. The decode unit 104 then selects (e.g., in the block of data or as a next received instruction 103) another instruction 103b that is sequentially next to the NOP instruction 103a to be fused into the fused NOP instruction 110.

In some implementations, after identifying the NOP instruction 103a, the decode unit 104 selects each NOP instruction n occurring after the identified NOP instruction 103a in the set of instructions 103 for fusion into the fused NOP instruction 110, if any. In some implementations, the decode unit 104 then generates the fused NOP instruction 110 to only reflect multiple NOP instructions. In some implementations, the decode unit 104 then generates the fused NOP instruction 110 to reflect any selected NOP instructions and the next non-NOP instruction 103c, for example.

In some implementations, the fused NOP instruction 110 includes a parameter indicating a total instruction size of the instructions 103a, 103b, or 103c fused into the fused NOP instruction 110. An instruction size is an amount of memory used to encode the given instruction. For example, assuming a NOP instruction 103a having a size of M and the at least one other instruction 103b and/or 103c having a size N, the fused NOP instruction 110 will include a parameter indicating an instruction size of M+N. Thus, on execution of the single, fused NOP instruction 110, the instruction pointer 105 is incremented by M+N.

In some implementations, the fused NOP instruction 110 includes a parameter indicating a number of instructions 103 fused into the fused NOP instruction 110. For example, in some implementations, particular processor 100 architectures require or benefit from tracking a number of instructions executed. Accordingly, assuming a fused NOP instruction 110 based off a NOP instruction and N other instructions, the fused NOP instruction 110 will include a parameter indicating a value of N+1.

In some implementations, the fused NOP instruction 110 includes a flag or parameter indicating that one or more NOP instructions 103 have been fused into the fused NOP instruction 110. For example, in implementations in which a NOP instruction is fused with at least one other NOP instruction, a parameter indicating a number of instructions 103 fused into the fused NOP instruction 110 also serves as a flag or parameter indicating that one or more NOP instructions have been fused into the fused NOP instruction 110. In other implementations, a separate bit flag is used.

In some implementations, the fused NOP instruction 110 includes an opcode corresponding to another instruction fused with the NOP instruction 103a. For example, where the fused NOP instruction 110 is based on only multiple NOP instructions, the fused NOP instruction 110 has an opcode for a NOP instruction. As another example, where the fused NOP instruction 110 is based on fusing an NOP instruction 103a with a non-NOP instruction, the fused NOP instruction 110 has a same opcode as the non-NOP instruction.

In some implementations, where the fused NOP instruction 110 is based on a non-NOP instruction, the fused NOP instruction 110 includes one or more parameters of the non-NOP instruction. Where the one or more parameters of the non-NOP instruction are modified during decode, the fused NOP instruction 110 includes the decoded one or more parameters.

After generating the fused NOP instruction 110, the fused NOP instruction 110 is provided to an execution unit 106 for execution. The execution unit 106 includes various logic and functional circuitry for execution of an instruction 103 as would be appreciated by one skilled in the art. The fused NOP instruction 110 is executed instead of individually executing the NOP instruction 103a and one or more other instructions 103b and/or 103c that are fused into the fused NOP instruction 110. In implementations, where the fused NOP instruction 110 is based on a non-NOP instruction, executing the fused NOP instruction 110 includes performing one or more operations associated with the non-NOP instruction.

In some implementations, executing the fused NOP instruction 110 includes incrementing the instruction pointer 105 by a total instruction size of the NOP instruction and the at least one other instruction. For example, in some implementations, the instruction pointer 105 is incremented according to a parameter in the fused NOP instruction 110 indicating the total instruction size. In some implementations, the instruction pointer 105 is incremented in response to a commitment or retirement of the fused NOP instruction 110.

Although execution of a NOP instruction 103 does not modify certain data or values by virtue of their execution, some amount of computational and power resources are necessarily used in order to execute the NOP instruction 103. Accordingly, by fusing the NOP instruction 103a with other instructions 103b and/or 103c, the same memory alignment padding provided by the NOP instruction 103a is achieved while only executing a single instruction, providing more efficient power usage when compared to requiring each individual instruction 103 to be passed through an execution pipeline.

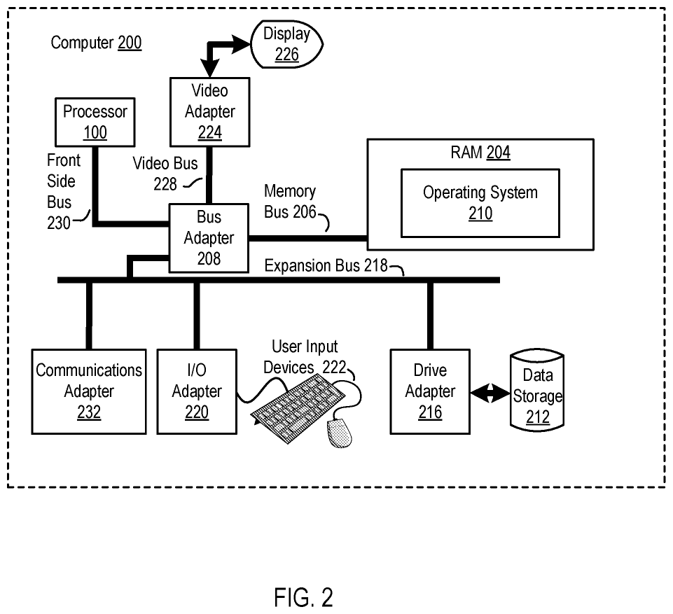

In some implementations, the processor 100 of FIG. 1 is implemented in a computer 200. In addition to at least one processor 100, the computer 200 of FIG. 2 includes random access memory (RAM) 204 which is connected through a high speed memory bus 206 and bus adapter 208 to processor 100 and to other components of the computer 200. Stored in RAM 204 is an operating system 210. The operating system 210 in the example of FIG. 2 is shown in RAM 204, but many components of such software typically are stored in non-volatile memory also, such as, for example, on data storage 212, such as a disk drive.

The computer 200 of FIG. 2 includes disk drive adapter 216 coupled through expansion bus 218 and bus adapter 208 to processor 100 and other components of the computer 200. Disk drive adapter 216 connects non-volatile data storage to the computer 200 in the form of data storage 212. Such disk drive adapters include Integrated Drive Electronics (‘IDE’) adapters, Small Computer System Interface (SCSI′) adapters, and others as will occur to those of skill in the art. In some implementations, non-volatile computer memory is implemented as an optical disk drive, electrically erasable programmable read-only memory (so-called ‘EEPROM’ or ‘Flash’ memory), RAM drives, and so on, as will occur to those of skill in the art.

The example computer 200 of FIG. 2 includes one or more input/output (′I/O′) adapters 220. I/O adapters implement user-oriented input/output through, for example, software drivers and computer hardware for controlling output to display devices such as computer display screens, as well as user input from user input devices 222 such as keyboards and mice. The example computer 200 of FIG. 2 includes a video adapter 224, which is an example of an I/O adapter specially designed for graphic output to a display device 226 such as a display screen or computer monitor. Video adapter 224 is connected to processor 100 through a high speed video bus 228, bus adapter 208, and the front side bus 230, which is also a high speed bus.

The exemplary computer 200 of FIG. 2 includes a communications adapter 232 for data communications with other computers and for data communications with a data communications network. Such data communications are carried out serially through RS-232 connections, through external buses such as a Universal Serial Bus (‘USB’), through data communications networks such as IP data communications networks, and/or in other ways as will occur to those of skill in the art. Communications adapters 232 implement the hardware level of data communications through which one computer sends data communications to another computer, directly or through a data communications network. Such communication adapters 232 include modems for wired dial-up communications, Ethernet (IEEE 802.3) adapters for wired data communications, and 802.11 adapters for wireless data communications.

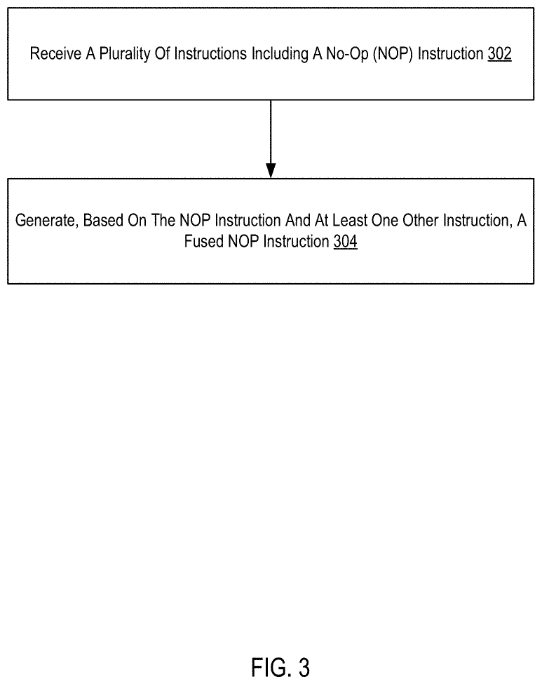

The approaches described above for fusing instructions into a fused NOP instruction are expounded below with regard to flowcharts FIG. 3 sets forth a flow chart illustrating an example method for fusing no-op (NOP) instructions according to some implementations of the present disclosure. The method of FIG. 3 is executed, for example, in a processor 100. The method of FIG. 3 includes receiving 302 a plurality of instructions 103 including a NOP instruction. For example, receiving 302 the plurality of instructions includes loading the instructions by an IFU and providing the instructions to a decode unit. The IFU loads one or more instructions from an address identified in an instruction pointer. The IFU then provides the loaded instructions to a decode unit for decoding.

The plurality of instructions includes a NOP instruction and at least one other instruction. In some implementations, the at least one other instruction includes one or more NOP instructions. In some implementations, the at least one other instruction includes a non-NOP instruction (e.g., an instruction 103 other than a NOP instruction). Examples of non-NOP instructions include ADD, LOAD. STORE, MOVE, SUB, AND, XOR, SHIFT, JUMP, CALL, RETURN, and the like.

The method of FIG. 3 also includes generating 304, based on the NOP instruction and the at least one other instruction, a fused NOP instruction. In some implementations, generating 304 the fused NOP instruction is performed by a decode unit. To generate the fused NOP instruction 110, the decode unit 104 identifies the NOP instruction and the at least one other instruction in a received block of instructions and selecting a fused NOP instruction opcode that replaces the NOP and other instruction(s). Additionally, the decode unit generates parameters of the fused NOP instruction based on the parameters of the instructions fused into the fused NOP instruction and based on type of other instructions fused into the fused NOP instruction.

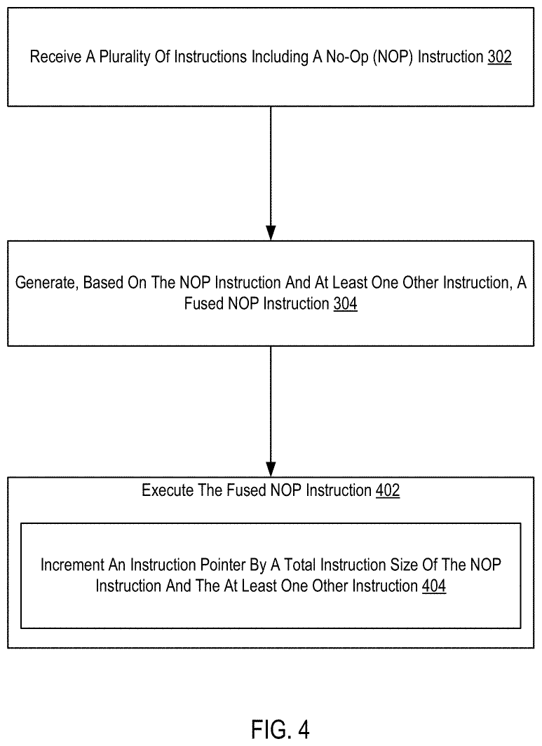

For further explanation, FIG. 4 sets forth a flow chart illustrating a variation of the example method for fusing no-op (NOP) instructions of FIG. 3. The method of FIG. 4 includes executing 402 the fused NOP instruction. Executing 402 the fused NOP instruction is performed, for example, by an execution unit of a processor such as the processor depicted in FIG. 1. Execution of the fused NOP instruction 110 results in the same resultant state as individually executing the multiple instructions fused into the fused NOP instruction. In implementations, where the fused NOP instruction is based on a non-NOP instruction, executing 402 the fused NOP instruction includes performing one or more operations associated with the non-NOP instruction. In implementations, for example, where the ‘other instruction’ fused into to the fused NOP instruction is an ADD instruction, the execution of the fused NOP instruction includes carrying out the operations of the individual ADD instruction.

In some implementations, executing 402 the fused NOP instruction includes incrementing 404 the instruction pointer by a total instruction size of the NOP instruction and the at least one other instruction. For example, in some implementations, the instruction pointer is incremented according to a parameter in the fused NOP instruction indicating the total instruction size. Such a parameter is generated when the fused NOP instruction is generated and is based on the instruction sizes of the individual instructions that are fused into the fused NOP instruction. In some implementations, the instruction pointer is incremented in response to a commitment or retirement of the fused NOP instruction.

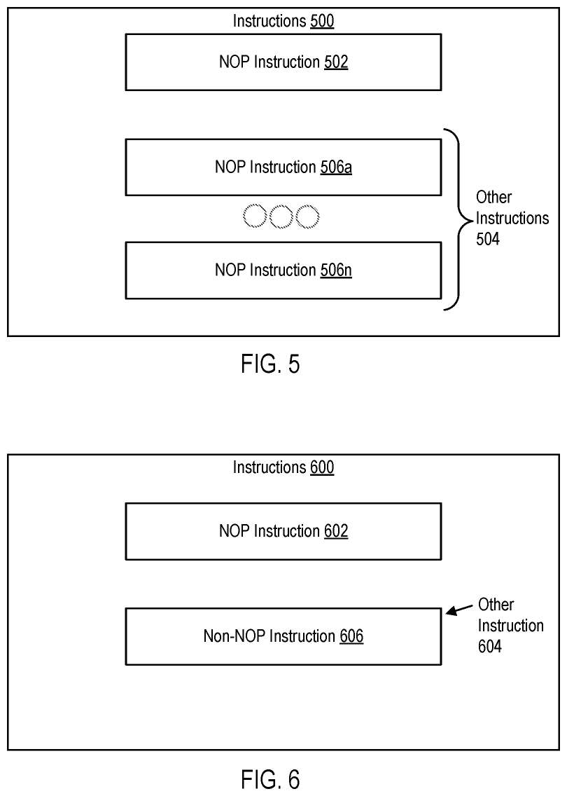

As mentioned above, a fused NOP instruction includes some combination of NOP instructions and/or non-NOP instructions. FIG. 5A depicts a set of instructions 500 that includes multiple NOP instructions 502, 506a-506n, some or all of which will be fused into a fused NOP instruction. More specifically, the instructions 500 include a first NOP instruction 502 followed by other instruction 504. The “other instructions” in this example include only NOP instructions 506a-506n. The multiple NOP instructions 502, 506a-506n are fused into a fused NOP instruction with a parameter that identifies the total instruction of all of the NOP instructions 502, 506a-506n. When the fused NOP instruction is executed, the instruction counter is incremented by the total instruction size specified in the parameter of the fused NOP instruction, thus affecting the same change in the instruction counter as would individual execution of the multiple NOP instructions 502, 506a-506n.

FIG. 6 depicts another example set of instructions 600. The example set of instructions 600 in FIG. 6 includes a NOP instruction 602 and another instruction 604, which will be fused into a fused NOP instruction. The “other instruction” in this example includes a non-NOP instructions 606, such as, for example and ADD instruction. The NOP instructions 602 is fused with the Non-NOP instruction 606 to generate a fused NOP instruction with a parameter that identifies the total instruction size the NOP instruction and Non-NOP instruction as well as with an opcode that identifies the operations to perform to effect the Non-NOP instruction. In the example of a fused NOP instruction with formed of a NOP and an ADD instruction, the opcode, for example, can be FNADD.

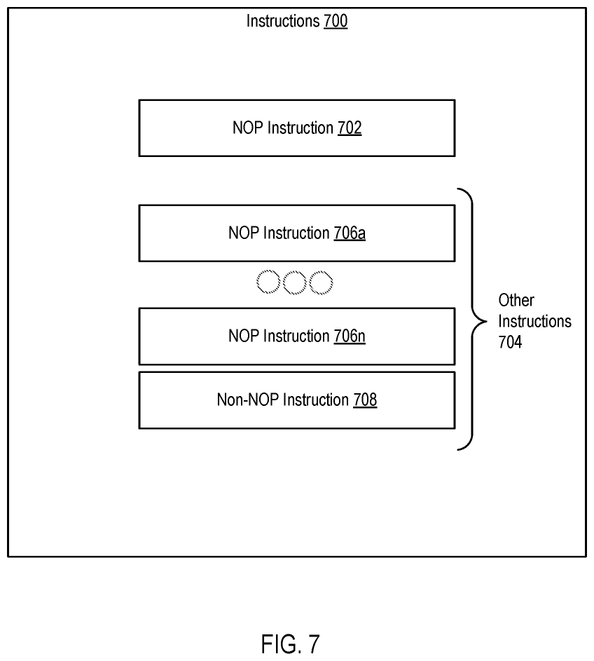

FIG. 7 depicts another example set of instructions 700. The example set of instructions 700 of FIG. 7 includes a NOP instruction 702 and other instructions 704 which will be fused into a fused NOP instruction. More specifically, the “other instructions” in the example of FIG. 7 include multiple NOP instructions 706a-706n and a Non-NOP instruction 708. The NOP instruction 702 is fused with the multiple NOP instructions 706a-706n and the Non-NOP instruction 708 to generate a fused NOP instruction with a parameter that identifies the total instruction size all of the individual instructions forming the fused NOP instruction. Additionally, the fused NOP instruction may include an opcode that identifies the operations to perform to effect the Non-NOP instruction.

In view of the explanations set forth above, readers will recognize that the benefits of fusing no-op (NOP) instructions include improved performance of a computing system by providing memory padding afforded by NOP instructions while only using the computational and power resources associated with executing a single instruction.

Exemplary implementations of the present disclosure are described largely in the context of a fully functional computer system for fusing no-op (NOP) instructions. Readers of skill in the art will recognize, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary implementations described in this specification are oriented to software installed and executing on computer hardware, nevertheless, alternative implementations implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some implementations, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various implementations of the present disclosure. The descriptions in this specification are for purposes of illustration only and are not to be construed in a limiting sense. The scope of the present disclosure is limited only by the language of the following claims.

1. A method of fusing no-op (NOP) instructions, the method comprising:
receiving a no-op (NOP) instruction; and
generating, based on the NOP instruction and at least one other instruction, a fused NOP instruction, wherein the fused NOP instruction includes a flag indicating the fused NOP instruction includes one or more NOP instructions.

2. The method of claim 1, further comprising executing the fused NOP instruction instead of individually executing the NOP instruction and the at least one other instruction.

3. The method of claim 2, wherein executing the fused NOP instruction comprises incrementing an instruction pointer by a total instruction size of the NOP instruction and the at least one other instruction.

4. The method of claim 1, wherein the at least one other instruction comprises a plurality of other NOP instructions.

5. The method of claim 1, wherein the at least one other instruction comprises one or more other NOP instructions and a non-NOP instruction.

6. The method of claim 1, wherein the fused NOP instruction comprises a parameter indicating a total instruction size of the NOP instruction and the at least one other instruction.

7. The method of claim 1, wherein the fused NOP instruction comprises a parameter indicating a number of instructions fused into the fused NOP instruction.

8. The method of claim 1, wherein the fused NOP instruction includes an opcode from the at least one other instruction.

9. A processor for fusing no-op (NOP) instructions, comprising:
an instruction fetch unit (IFU); and
a decode unit configured to:
receive, from the IFU, a plurality of instructions comprising a no-op (NOP) instruction; and
generate, based on the NOP instruction and at least one other instruction, a fused NOP instruction, wherein the fused NOP instruction includes a flag indicating the fused NOP instruction includes one or more NOP instructions.

10. The processor of claim 9, further comprising an execution unit, and wherein the decode unit is further configured to provide the fused NOP instruction to the execution unit.

11. The processor of claim 10, wherein the execution unit is configured to execute the fused NOP instruction by incrementing an instruction pointer by a total instruction size of the NOP instruction and the at least one other instruction.

12. The processor of claim 9, wherein the at least one other instruction comprises one or more other NOP instructions.

13. The processor of claim 9, wherein the at least one other instruction comprises a non-NOP instruction.

14. The processor of claim 9, wherein the fused NOP instruction comprises a parameter indicating a total instruction size of the NOP instruction and the at least one other instruction.

15. The processor of claim 9, wherein the fused NOP instruction comprises a parameter indicating a number of instructions fused into the fused NOP instruction.

16. An apparatus for fusing no-op (NOP) instructions, comprising:
computer memory; and
a processor operatively coupled to the computer memory, the processor comprising:
an instruction fetch unit (IFU) configured to load a plurality of instructions from memory, wherein the plurality of instructions comprise a no-op (NOP) instruction; and
a decode unit configured to:
receive, from the IFU, the plurality of instructions; and
generate, based on the NOP instruction and at least one other instruction, a fused NOP instruction, wherein the fused NOP instruction includes a flag indicating the fused NOP instruction includes one or more NOP instructions.

17. The apparatus of claim 16, wherein the processor further comprises an execution unit, and wherein the decode unit is further configured to provide the fused NOP instruction to the execution unit.

18. The apparatus of claim 17, wherein the execution unit is configured to execute the fused NOP instruction by incrementing an instruction pointer by a total instruction size of the NOP instruction and the at least one other instruction.

19. The apparatus of claim 16, wherein the at least one other instruction comprises one or more other NOP instructions.

20. The apparatus of claim 16, wherein the at least one other instruction comprises a non-NOP instruction.
